(19) United States
(12) Patent Application Publication
(10) Pub. No.: US 2009/0220321 A1
(43) Pub. Date: Sep. 3, 2009

(54) FASTENING METAL FITTING

(75) Inventor: YOSHIKAZU SAKAMURA, KUSE-GUN (JP)

Correspondence Address: BARNES & THORNBURG LLP, 750-17TH STREET NW, SUITE 900, WASHINGTON, DC, 20006-4675, US

(73) Assignee: SAKAMURA MACHINE CO., LTD., Kuse-gun (JP)

(21) Appl. No.: 12/393,430

(22) Filed: Feb. 26, 2009

(30) Foreign Application Priority Data
Feb. 28, 2008 (JP) 2008-1863
Jan. 19, 2009 (JP) 2009-681

(51) Int. Cl. F16B 23/00

(52) U.S. Cl. 411/410

(57) ABSTRACT

The fastening metal fitting which allows satisfactory fastening by a hexalobular wrench at the time of assembly and allows loosing or fastening not only by a hexalobular wrench but also by a wide use of wrenches such as a common hexagon wrench at the time of disassembly and repair, which includes the head and the axial portion having the screw portion, in which at the center of the head, the tool insertion hole is formed with the hexagonal socket portion and the circularly-arced notched portions outwardly protruding from the respective corners of the socket portion which are provided at the corners continuously. The bolt which can be fastened or loosen by a wide use of a 12-point wrench, an open-end wrench for a hexagon head bolt or a square head bolt, a common hexagon wrench and a hexalobular wrench is formed to be a regular square as seen from the top with the four triangular projections on diagonals of the vertical line and the horizontal line passing the center of a regular dodecagon removed from the regular dodecagon and is formed to have the V-shaped engaging slots left at the respective corners, as well as having, at the center of the head, the hole of a regular hexagonal shape which has the circularly-arced notched portions outwardly protruding from the respective corners of the hole which are provided at the corners continuously.

### TECHNICAL FIELD

The present invention relates to a fastening metal fitting such as a bolt, a plug and a socket screw.

### BACKGROUND ART

Conventionally, it is a common practice to use, for example, as a fastening bolt for automobiles, a hexagonal socket head bolt formed of a head and an axial portion having a screw portion on its circumference, with a hexagonal socket formed at the center of the head. The hexagonal socket head bolt is fastened by a predetermined fastening axial force generated by the insertion of a hexagon wrench widely used in common into a hexagonal socket.

Also known as a fastening bolt for increasing a fastening force is a hexalobular socket head bolt whose cylindrical head has a hexalobular socket formed at its center with a circular curve continuing. The hexalobular socket head bolt is fastened by a predetermined fastening axial force generated by the insertion, into the above hexalobular socket, of a hexalobular wrench whose shape is the same as that of the above hexalobular socket and whose shape is special to fit the socket.

### SUMMARY OF THE INVENTION

While the latter hexalobular socket head bolt has an advantage that torque is completely transmitted to securely fasten a target object, it has a problem that without a hexalobular wrench having a special shape at hand, the target object can be neither disassembled nor repaired to leave nothing to do with it. Under these circumstances, hexagonal socket head bolts are frequently adopted which allow disassembly and repair by a hexagon wrench widely used in common that is easily available.

Thus, the present invention aims at providing a fastening metal fitting which allows sufficient fastening by a hexalobular wrench at the time of assembly and which can be loosen or fastened by widely using not only a hexalobular wrench but also a common hexagon wrench at the time of disassembly and repair.

### MEANS FOR SOLVING THE PROBLEM

In order to solve the above-described problem, the fastening metal fitting according to the present invention is formed of a head and an axial portion having a screw portion, in which formed at the center of the head is a tool insertion hole with a hexagonal socket portion and circularly-arced notched portions outwardly protruding from the respective corners of the socket portion which are provided at the corners continuously.

The fastening metal fitting according to the present invention has, in addition to the above-described components, either one or both of a “+”-shaped slot and a single slot formed at the bottom of the tool insertion hole.

In addition to the above-described components, the fastening metal fitting according to the present invention is characterized in having a head whose shape is cylindrical.

The bolt according to the present invention is formed of a head and an axial portion having a screw portion, whose head has a regular square shape as seen from the top which is obtained by removing, from a regular dodecagon, four triangular projections on diagonals of a vertical line and a horizontal line passing the center of the regular dodecagon and has each corner formed to have a V-shaped engaging slot left, and whose head has, at its center, a hole whose shape is regular hexagonal and which has circularly-arced notched portions outwardly protruding from the respective corners of the hole which are provided at the corners continuously.

### EFFECTS OF THE INVENTION

The fastening metal fitting according to the present invention can be widely used for a common hexagon wrench or a hexalobular wrench because of a shape of a tool insertion hole. As a result, at the time of assembly of a target object, a hexalobular wrench enables satisfactory fastening to be realized and a fastening axial force to be managed with ease. On the other hand, at the time of disassembly and repair of the target object, even without a hexalobular wrench having a special shape at hand, use of a hexagon wrench widely used in common enables loosing and fastening.

In addition, the fastening metal fitting according to the present invention is lighter in weight than a common hexagonal socket head bolt.

Furthermore, the fastening metal fitting according to the present invention, when having either one or both of a “+”-shaped slot and a single slot formed at the bottom of a tool insertion hole, allows a wide use of a minus screw key and a plus screw key in addition to a common hexagon wrench and a hexalobular wrench.

Since the bolt according to the present invention has a head whose shape as seen from the top is regular square, at the time of assembling a target object, a rotation angle can be visually checked with ease. As a result, at the time of another fastening based on the rotation angle after primary fastening, a fastening axial force can be managed with ease.

The bolt according to the present invention, at its fastening or loosing, allows a wide use of a 12-point wrench, and an open-end wrench for a hexagon head bolt or a square head bolt because of its head shape, as well as allowing a wide use of a common hexagon wrench and a hexalobular wrench because of a shape of a hole at the center of the head.

### BRIEF DESCRIPTION OF THE DRAWINGS

FIG. 1 is a plan view of a fastening bolt according to a first embodiment of the present invention.

FIG. 2 is a front view of the fastening bolt.

FIG. 3 is a longitudinal sectional view of the fastening bolt.

FIG. 4 is a view for use in explaining a state where the fastening bolt is used by a hexalobular wrench.

FIG. 5 is a view for use in explaining a state where the fastening bolt is used by a hexagon wrench.

FIG. 6 is a plan view of a fastening bolt according to a second embodiment of the present invention.

FIG. 7 is a longitudinal sectional view of the fastening bolt.

FIG. 8 is a plan view of a fastening bolt according to a third embodiment of the present invention.

FIG. 9 is a longitudinal sectional view of the fastening bolt.

FIG. 10 is a plan view of a bolt according to a fourth embodiment of the present invention.

FIG. 11 is a front view of the bolt.

FIG. 12 is a view for use in explaining a state where the bolt is used by a 12-point wrench.

FIG. 13 is a view for use in explaining a state where the bolt is used by an open-end wrench.

FIG. 14 is a view for use in explaining a state where the bolt is used by a 7-point open-end wrench.

FIG. 15 is a view for use in explaining a state where the bolt is used by a hexagon wrench.

FIG. 16 is a view for use in explaining a state where the bolt is used by a hexalobular wrench.

### EMBODIMENTS OF THE PRESENT INVENTION

In the following, embodiments of the present invention will be described with reference to the drawings.

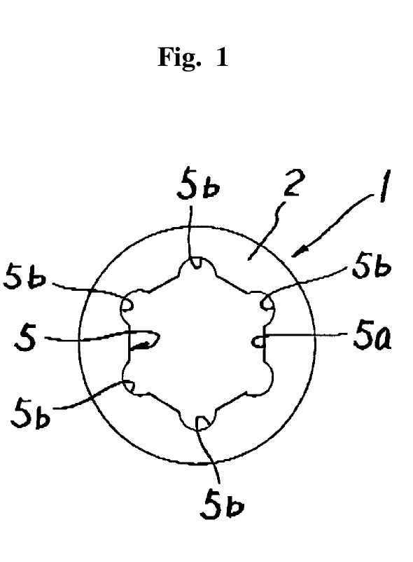

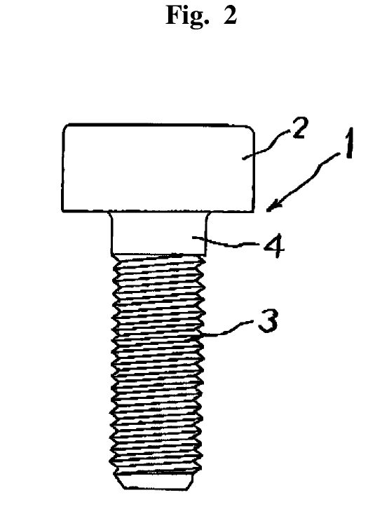

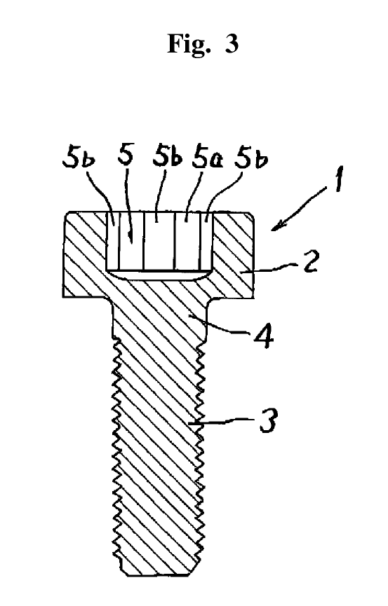

As shown in FIG. 1 through FIG. 3, a fastening bolt (fastening metal fitting) 1 according to a first embodiment of the present invention includes a cylindrical head 2 having a large diameter and an axial portion 4 with a small diameter which has a screw portion 3 on its circumference. At the center of the head 2, a tool insertion hole 5 is formed. The tool insertion hole 5 is formed of a hexagonal socket portion 5a and circularly-arced notched portions 5b . . . 5b outwardly protruding from the respective corners of the socket portion 5a which are provided at the corners continuously.

Next, functions of the fastening bolt 1 will be described.

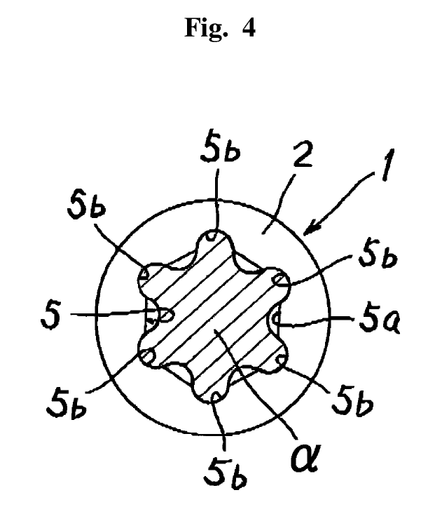

First, at the time of assembly, inserting a hexalobular wrench a into the circularly-arced notched portions 5b . . . 5b of the tool insertion hole 5 to fasten the fastening bolt 1 as shown in FIG. 4 realizes reliable fastening.

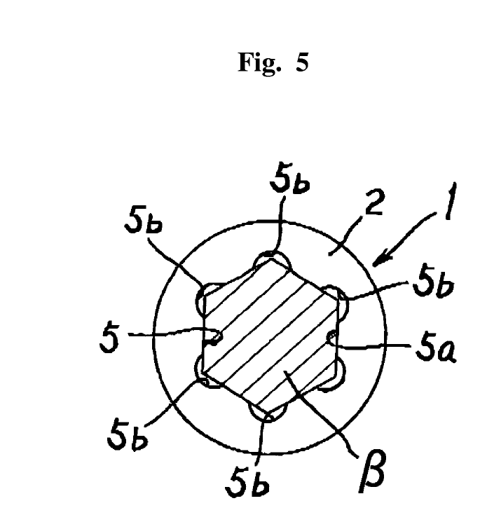

On the other hand, at the time of disassembly and repair, it is possible not only to extract the fastening bolt 1 by the hexalobular wrench a but also, even without the hexalobular wrench α at hand, to execute disassembly and repair by inserting a common hexagon wrench β widely used into the hexagonal socket portion 5a of the tool insertion hole 5 and loosing or fastening the fastening bolt 1 as shown in FIG. 5.

Thus, the fastening bolt 1 according to the first embodiment allows a wide use of the hexalobular wrench α and the common hexagon wrench β because of a shape of the tool insertion hole 5. As a result, a fastening axial force can be managed with ease. Moreover, the bolt can be made lighter in weight than a common hexagonal socket head bolt.

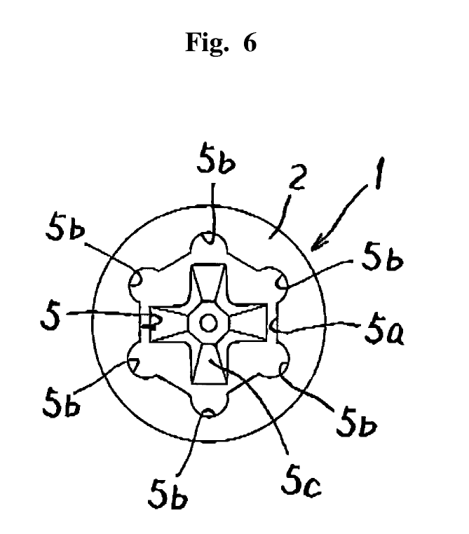

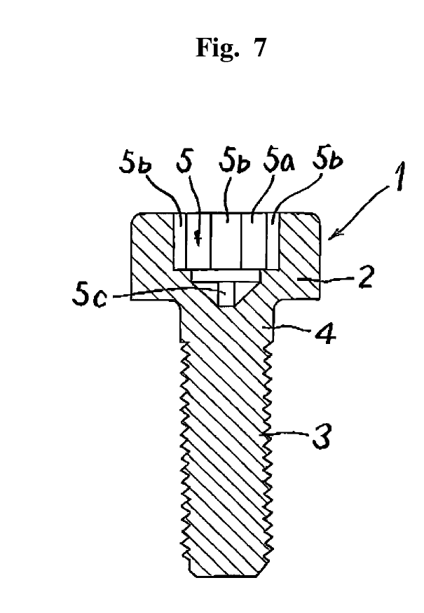

As shown in FIG. 6 and FIG. 7, the fastening bolt 1 according to a second embodiment of the present invention has a “+”-shaped slot 5c formed at the bottom of the tool insertion hole 5. The fastening bolt 1 allows a use of a plus screw key (not shown) in addition to the hexalobular wrench α and the common hexagon wrench β.

In place of the “+”-shaped slot 5c, a single slot may be formed. In such a case, a minus screw key (not shown) can be used in place of a plus screw key.

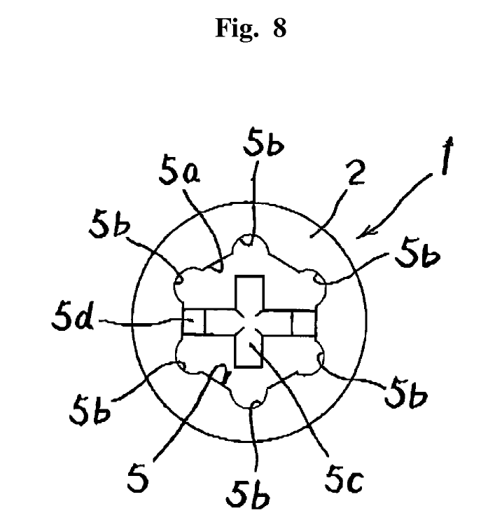

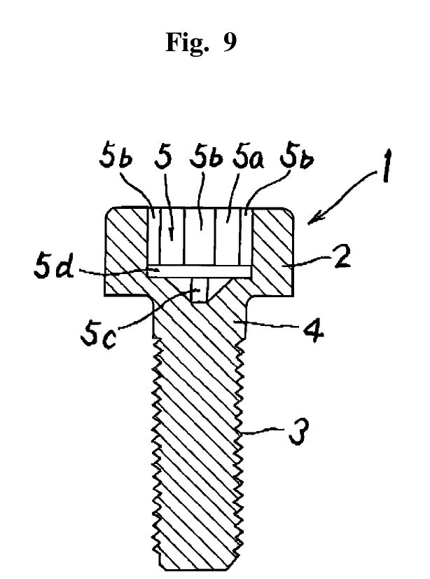

As shown in FIG. 8 and FIG. 9, the fastening bolt 1 according to a third embodiment of the present invention has the “+”-shaped slot 5c and a single slot 5d formed together at the bottom of the tool insertion hole 5. The fastening bolt 1 allows a wide use of a plus screw key and a minus screw key (both of which are not shown) in addition to the hexalobular wrench α and the common hexagon wrench β.

While in the above-described embodiments, the present invention is applied to the fastening bolt 1 with the cylindrical head 2 having a large diameter, it is not limited to such fastening bolt 1 but be widely applicable to fastening metal fittings of various shapes such as a plug and a socket screw.

Next, a fourth embodiment of the present invention will be described.

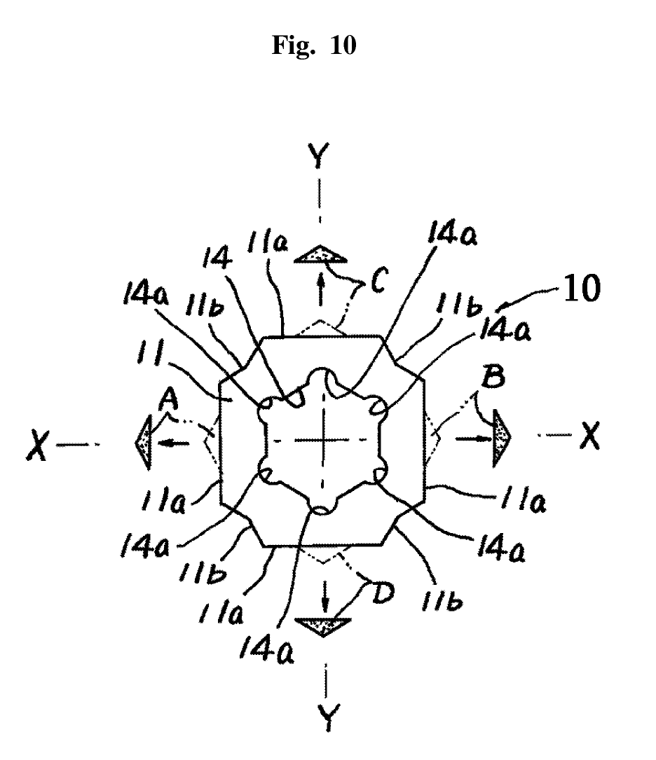

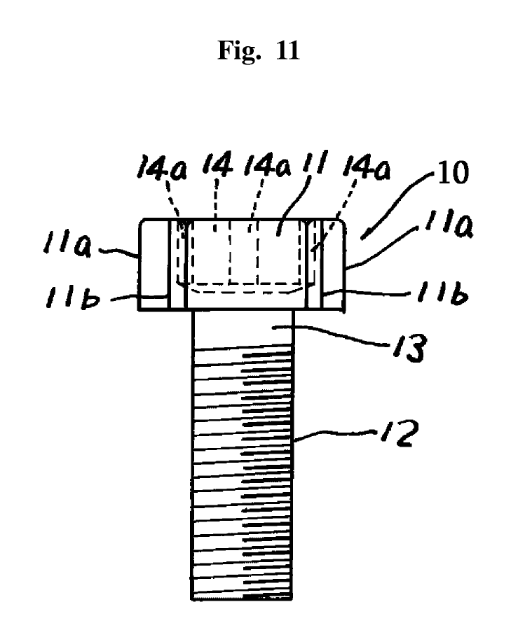

FIG. 10 and FIG. 11 show a bolt 10 for automobiles according to the fourth embodiment of the present invention. The bolt 10 is formed of a head 11 and an axial portion 13 with a screw 12 formed on its circumference.

The head 11, as shown by a virtual line in FIG. 10, is formed to be a regular square as seen from the top with four triangular projections A, B, C and D removed from a regular dodecagon which are on diagonals of the vertical line X-X and the horizontal line Y-Y passing the center of the regular dodecagon. Furthermore, the head 11 is formed to have V-shaped engaging slots 11b . . . 11b which allow a 12-point wrench L to fit left at the respective corners of its four sides 11a . . . 11a.

Length of each side of the four sides 11a . . . 11a is designed to be the same as a length of one side of a head of a common hexagon bolt.

Formed at the center of the head 11 is a regular hexagonal hole 14 with circularly-arced notched portions 14a . . . 14a outwardly protruding from the respective corners of the hole 14 which are provided at the corners continuously.

Next, functions of the bolt 10 according to the fourth embodiment will be described.

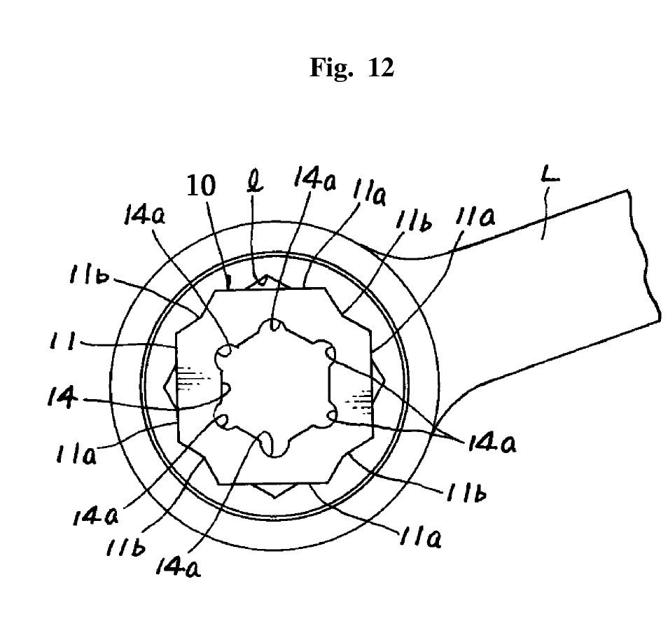

First, at the time of fastening, the bolt 10 is fastened by a predetermined axial force by using a 12-point torque wrench L as shown in FIG. 12. In this case, as a 12-point torque wrench L, a manually-operated, electric-steering, or box-end wrench can be used.

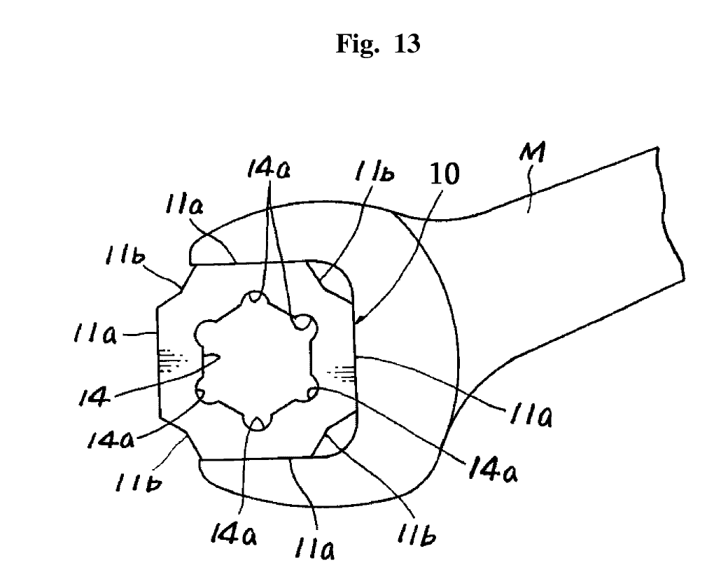

On the other hand, at the time of disassembly and repair, the bolt 10 may be extracted by the 12-point torque wrench L, or without the 12-point torque wrench L in the mountains, the bolt 10 can be extracted by using an open-end wrench M for a hexagon head bolt or a square head bolt as shown in FIG. 13.

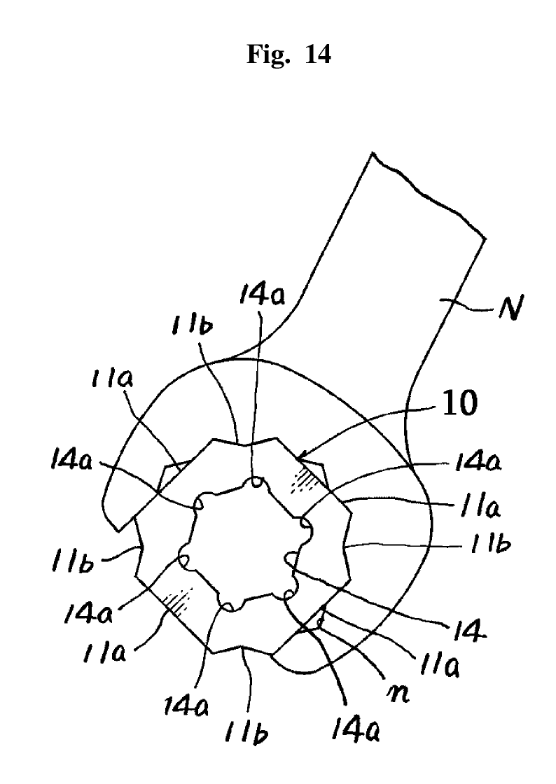

As shown in FIG. 14, the bolt 10 can be extracted also by using a 7-point open-end wrench N having seven engaging portions n . . . n.

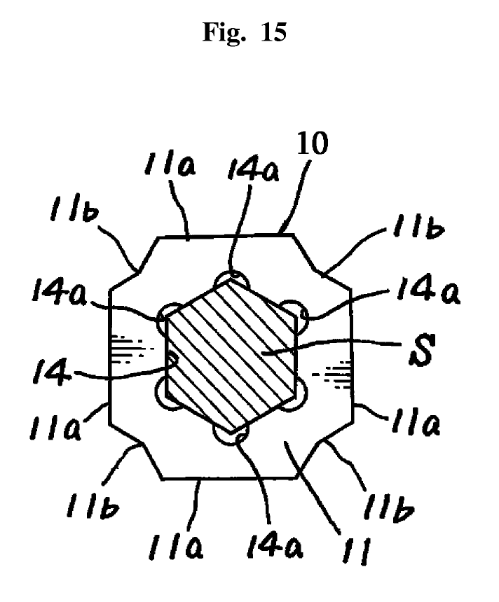

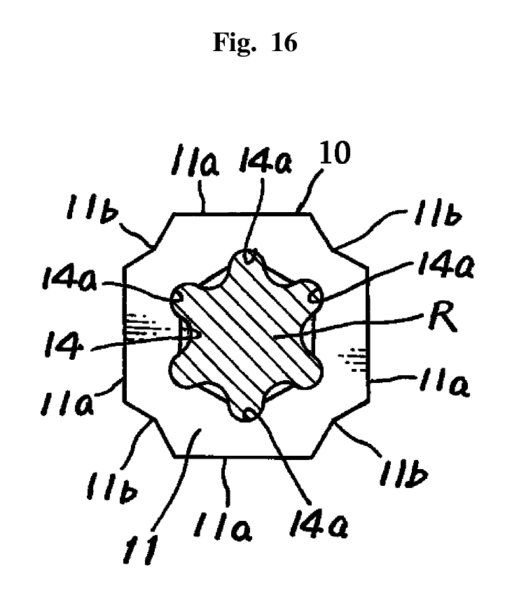

Furthermore, the bolt 10 can be extracted by using a hexagon wrench S fitting the hole 14 at the center of the head 11 as shown in FIG. 15 or by a hexalobular wrench R fitting the circularly-arced notched portions 14a . . . 14a of the hole 14 as shown in FIG. 16.

Then, also at further fastening after disassembly and repair, a wide range of wrenches can be used such as the above-described 12-point torque wrench L, open-end wrench M for a hexagon head bolt or a square head bolt, 7-point open-end wrench N, hexagon wrench S and hexalobular wrench R.

Then, at the time of fastening, after primary fastening executed until the bolt 10 has no clearance, fastening to a predetermined angle, for example, 120° or 180° while looking at the movement of the four sides 11a . . . 11a of the head 11 whose shape as seen from the top is regular square enables the bolt 10 to be fastened by a predetermined axial force. This enables an axial force at the time of fastening to be simply managed with ease.

Also because the head 11 has a regular square shape, the bolt 10 can be made lighter in weight than that whose head is regular hexagonal.

Although the present invention is applied to the bolt 10 for automobiles in the fourth embodiment, the invention is not limited thereto but applicable to bolts for all the other purposes.

What is claimed is:

1. A fastening metal fitting, comprising a head and an axial portion having a screw portion, wherein at the center of the head, a tool insertion hole is formed with a hexagonal socket portion and circularly-arced notched portions outwardly protruding from the respective corners of the socket portion which are provided at the corners continuously.

2. The fastening metal fitting according to claim 1, wherein at the bottom of the tool insertion hole, either one or both of a “+”-shaped slot and a single slot are formed.

3. The fastening metal fitting according to claim 1, wherein the head is cylindrical.

4. A bolt, comprising a head and an axial portion having a screw portion, wherein
the head is formed to be a regular square as seen from the top with four triangular projections on diagonals of the vertical line and the horizontal line passing the center of a regular dodecagon removed from the regular dodecagon and to have V-shaped engaging slots left at the respective corners, and
at the center of the head, a hole is formed to have a regular hexagonal shape and to have circularly-arced notched portions outwardly protruding from the respective corners of the hole which are provided at the corners continuously.
